(19) United States
(12) Patent Application Publication
(10) Pub. No.: US 2003/0017757 A1
(43) Pub. Date: Jan. 23, 2003

(54) Connector terminal

(75) Inventors: Takao Murakami, Shizuoka-ken (JP); Chieko Torii, Shizuoka-ken (JP)

Correspondence Address: Finnegan, Henderson, Farabow,, Garrett & Dunner, L.L.P., 1300 I Street, N.W., Washington, DC, 20005-3315, US

(73) Assignee: YAZAKI CORPORATION

(21) Appl. No.: 10/196,164

(22) Filed: Jul. 17, 2002

(30) Foreign Application Priority Data
Jul. 19, 2001 (JP) P 2001-220545

(51) Int. Cl. H01R 13/02

(52) U.S. Cl. 439/884

(57) ABSTRACT

A connector terminal which includes a terminal base portion; and a tab extending from the terminal base portion to come into contact with an opponent terminal. The tab includes a bottom face portion and a folded portion extending from the bottom face portion formed by bending. The bottom face portion and the folded portion at a foot portion of the tab overlap each other to constitute at least a threefold structure.

### BACKGROUND OF THE INVENTION

1. Field of the Invention

The present invention relates to connector terminals, more specifically, to a connector terminal having a tab to be inserted into an opponent terminal.

2. Description of the Related Art

A conceivable connector terminal formed by bending a metal plate of a predetermined shape includes a terminal base portion and a tab extending from the terminal base portion.

The tab is composed of a bottom face portion and a pair of folded portions formed by bending a portion extending from the bottom face portion. The folded portions substantially contact to the bottom face portion of the tab. Edges of the both folded portions abut on each other nearly in the center of the bottom face portion of the tab. An overlap of the bottom face portion of the tab and the folded portions thereof is made twofold in the entire region from a foot portion to a tip end portion of the tab. Therefore, there is a problem that strength or rigidity of the foot portion of the tab is insufficient.

### SUMMARY OF THE INVENTION

The object of the present invention is to provide a connector terminal having a tab with a strong and rigid foot portion.

An aspect of the present invention is a connector terminal comprising: a terminal base portion; and a tab extending from the terminal base portion to come into contact with an opponent terminal, the tab including: a bottom face portion; and a folded portion extending from the bottom face portion formed by bending, wherein the bottom face portion and the folded portion at a foot portion of the tab overlap each other to constitute at least a threefold structure.

According to the aspect constituted as described above, the foot portion of the tab is given high geometrical moment of inertia and section modulus, thus enhancing strength and rigidity of the foot portion of the tab.

### BRIEF DESCRIPTION OF THE DRAWINGS

The invention will now be described with reference to the accompanying drawings, wherein:

FIG. 1A is a plan view of a connector terminal according to a first embodiment of the present invention.

FIG. 1B is a front view of the connector terminal shown in FIG. 1A.

FIG. 1C is an enlarged cross-sectional view of the connector terminal shown in FIG. 1A, which is taken along the IC-IC line in FIG. 1B.

FIG. 2A is a plan view of a connector terminal according to a second embodiment of the present invention.

FIG. 2B is a front view of the connector terminal shown in FIG. 2A.

FIG. 2C is an enlarged cross-sectional view of the connector terminal shown in FIG. 2A, which is taken along the IIC-IIC line in FIG. 2B.

FIG. 2D is an enlarged cross-sectional view of the connector terminal shown in FIG. 2A, which is taken along the IID-IID line in FIG. 2B.

FIG. 3A is a plan view of a connector terminal according to a third embodiment of the present invention.

FIG. 3B is a front view of the connector terminal shown in FIG. 3A.

FIG. 3C is an enlarged cross-sectional view of the connector terminal shown in FIG. 3A, which is taken along the IIIC-IIIC line in FIG. 3B.

FIG. 3D is an enlarged cross-sectional view of the connector terminal shown in FIG. 3A, which is taken along the IIID-IIID line in FIG. 3B.

### DETAILED DESCRIPTION OF THE PREFERRED EMBODIMENTS

Embodiments of the present invention will be explained below with reference to the drawings, wherein like members are designated by like reference characters.

[First Embodiment]

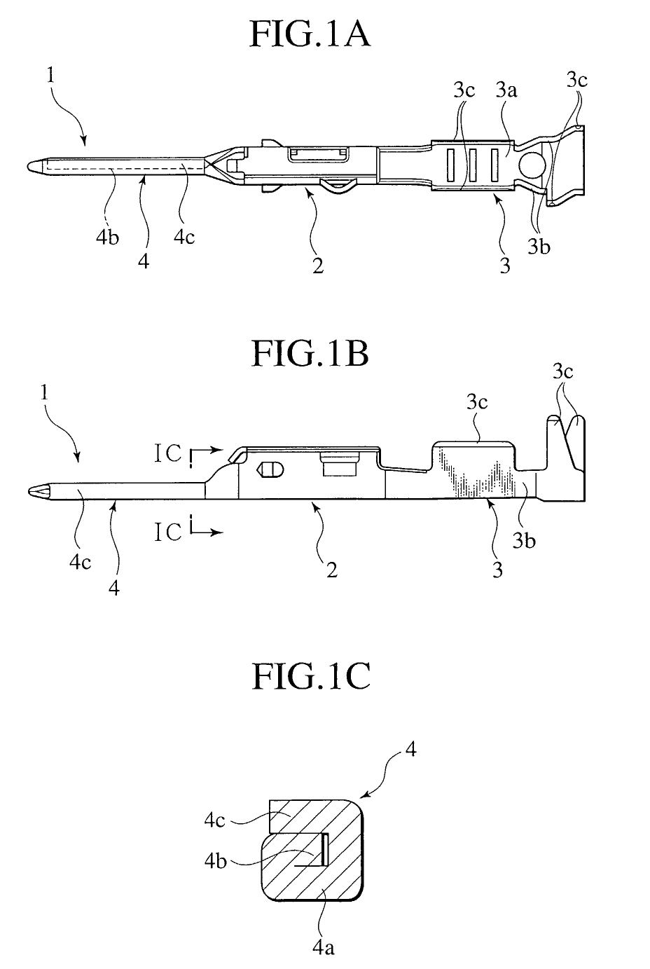

As shown in FIGS. 1A and 1B, a connector terminal 1 is formed by bending a metal plate of a predetermined shape. The connector terminal 1 is composed of a terminal base portion 2, an electric wire fixing portion 3 extending on a back end of the terminal base portion 2, and a tab 4 extending on a tip end of the terminal base portion 2 for contact with an opponent terminal. The electric wire fixing portion 3 includes a bottom face portion 3a, a pair of side plate portions 3b standing on the right and left sides of the bottom face portion 3a, and electric wire caulking portions 3c extending above the respective side plate portions 3b. Moreover, an end of an electric wire (not shown) is inserted into a space defined by the bottom face portion 3a and the pair of side plate portions 3b, and the electric wire is fastened by bending the electric wire caulking portions 3c so as to overlap the inserted electric wire.

The tab 4 includes a bottom face portion 4a, a first folded portion 4b formed by bending a portion extending from one of right and left sides of the bottom face portion 4a, and a second folded portion 4c formed by bending another portion extending from the other one of the right and left sides thereof. The first folded portion 4b is provided almost all over from a foot portion to a tip end portion and bent so that a lower plane thereof comes into substantial contact with the bottom face portion 4a. The second folded portion 4c is provided almost all over from a foot portion to a tip end portion and bent so that a lower plane thereof comes into substantial contact with the first folded portion 4b. In other words, the second folded portion 4c and the first folded portion 4b are bent in an overlapping manner. Moreover, the first and the second folded portions 4b and 4c are bent uniformly all over from the foot portions to the tip end portions in the same condition. Accordingly, as described in detail in FIG. 1C, the tab 4 is formed as threefold as a whole including the foot portion, with the bottom face portion 4a and the first and the second folded portions 4b and 4c.

According to the connector terminal 1, the foot portion of the tab 4 is formed as threefold consisting of the bottom face portion 4a and the first and the second folded portions 4b and 4c. Therefore, the foot portion of the tab 4 is given high geometrical moment of inertia and section modulus, thus enhancing strength and rigidity of the foot portion of the tab 4.

Moreover, according to the above-described first embodiment, the first and the second folded portions 4b and 4c of the tab 4 are bent uniformly all over from the foot portions to the tip end portions in the same condition. Therefore, geometrical moment of inertial and a section modulus of any portion other than the foot portion of the tab 4 are increased, thus enhancing strength and rigidity of any portion other than the foot portion of the tab 4. As a result, strength and rigidity are enhanced throughout the tab 4.

[Second Embodiment]

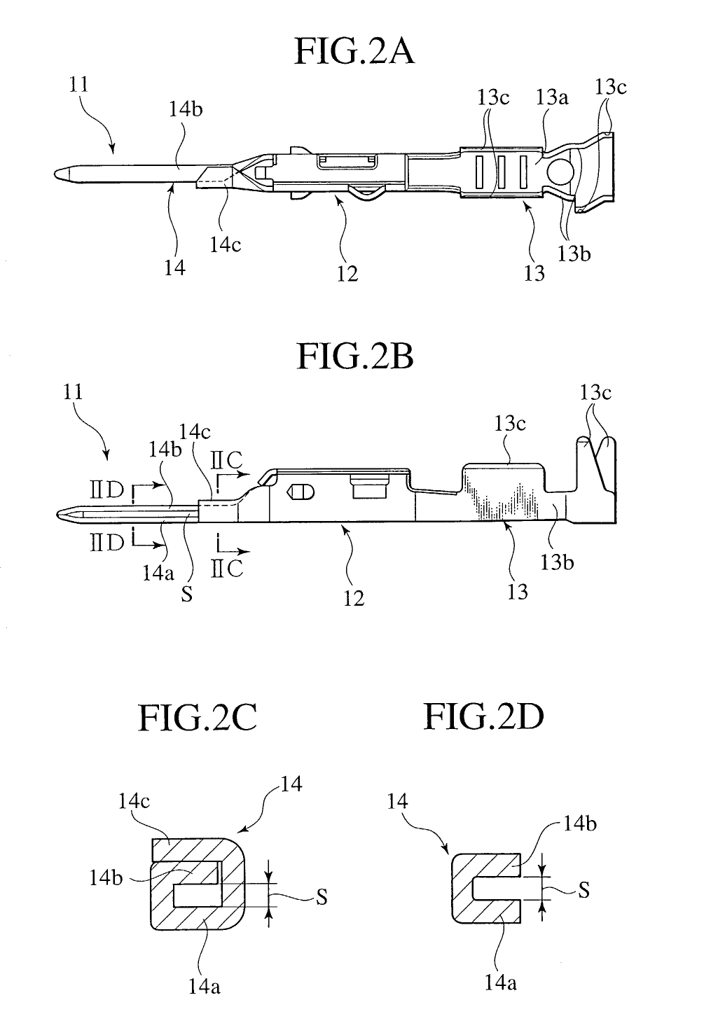

As shown in FIGS. 2A and 2B, a connector terminal 11 is formed by bending a metal plate of a predetermined shape. The connector terminal 11 is composed of a terminal base portion 12, an electric wire fixing portion 13 extending on a back end of the terminal base portion 12, and a tab 14 extending on a tip end of the terminal base portion 12 for contact with an opponent terminal. The electric wire fixing portion 13 includes a bottom face portion 13a, a pair of side plate portions 13b standing on the right and left sides of the bottom face portion 13a, and electric wire caulking portions 13c extending above the respective side plate portions 13b. Moreover, an end of an electric wire (not shown) is inserted into a space defined by the bottom face portion 13a and the pair of side plate portions 13b, and the electric wire is fastened by bending the electric wire caulking portions 13c so as to overlap the inserted electric wire.

The tab 14 includes a bottom face portion 14a, a first folded portion 14b formed by bending a portion extending from one of right and left sides of the bottom face portion 14a, and a second folded portion 14c formed by bending another portion extending from the other one of the right and left sides thereof. The first folded portion 14b is provided all over from a foot portion to a tip end portion and bent such that a lower plane thereof overlaps the bottom face portion 14a with provision of a space S as shown in FIG. 2D. The second folded portion 14c is provided only on the foot portion and bent such that a lower plane thereof comes into substantial contact with the first folded portion 14b as shown in FIG. 2C. In other words, the second folded portion 14c and the first folded portion 14b are disposed with provision of the space S against the bottom face portion 14a and bent in an overlapping manner. Accordingly, the foot portion of the tab 14 is formed as threefold consisting of the bottom face portion 14a and the first and the second folded portions 14b and 14c, and the portion other than the foot portion of the tab 14 is formed as twofold consisting of the bottom face portion 14a and the first folded portion 14b, respectively.

According to the connector terminal 11, the foot portion of the tab 14 is formed as threefold consisting of the bottom face portion 14a and the first and the second folded portions 14b and 14c. Therefore, the foot portion of the tab 14 is given high geometrical moment of inertia and section modulus, thus enhancing strength and rigidity of the foot portion of the tab 14.

Moreover, according to the above-described second embodiment, the first and the second folded portions 14b and 14c of the foot portion of the tab 14 are bent so as to overlap each other with provision of the space S against the bottom face portion 14a. Therefore, the foot portion of the tab 14 shows geometrical moment of inertia and a section modulus which are higher than those in the case of overlapping the bottom face portion 14a, and the first and the second folded portions 14b and 14c in substantially contacting manner (the first embodiment). Hence, strength and rigidity of the foot portion of the tab 14 are further enhanced.

Moreover, according to the second embodiment, the first folded portion 14b of the portion other than the foot portion of the tab 14 is bent so as to overlap the bottom face portion 14a with provision of the space S. Therefore, the portion other than the foot portion of the tab 14 also shows geometrical moment of inertia and a section modulus which are higher than those in the case of overlapping the bottom face portion 14a, and the first and the second folded portions 14b and 14c in a substantially contacting manner (the first embodiment). Hence, strength and rigidity of any portion other than the foot portion of the tab 14 are also enhanced. As a result, strength and rigidity are enhanced throughout the tab 14.

[Third Embodiment]

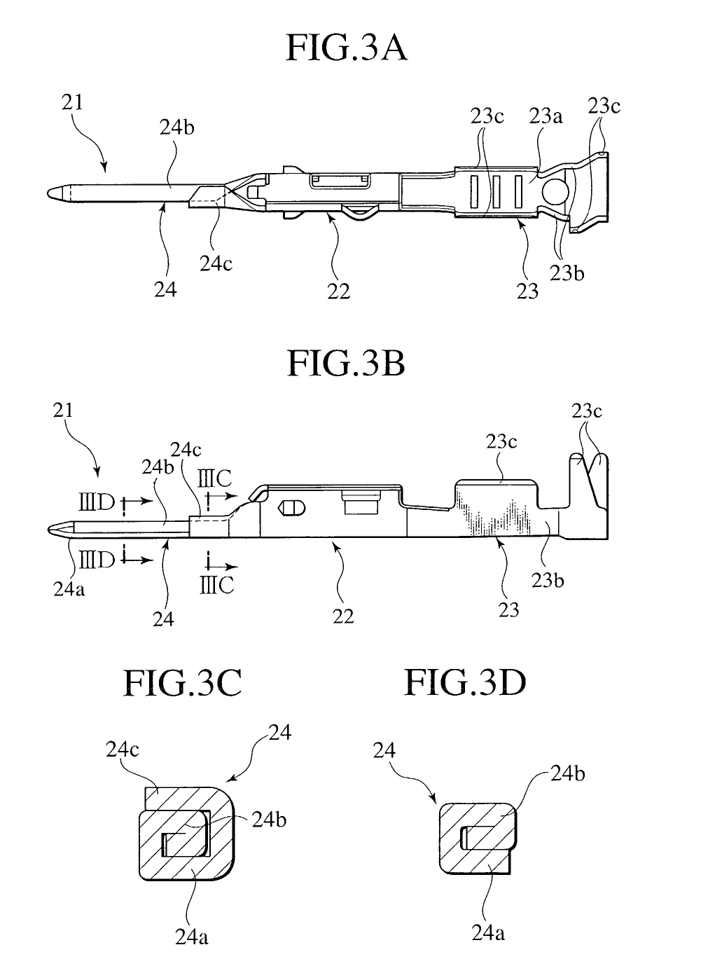

As shown in FIGS. 3A and 3B, a connector terminal 21 is formed by bending a metal plate of a predetermined shape. The connector terminal 21 is composed of a terminal base portion 22, an electric wire fixing portion 23 extending on a back end of the terminal base portion 22, and a tab 24 extending on a tip end of the terminal base portion 22 for contact with an opponent terminal. The electric wire fixing portion 23 includes a bottom face portion 23a, a pair of side plate portions 23b standing on the right and left sides of the bottom face portion 23a, and electric wire caulking portions 23c extending above the respective side plate portions 23b. Moreover, an end of an electric wire (not shown) is inserted into a space defined by the bottom face portion 23a and the pair of side plate portions 23b, and the electric wire is fastened by bending the electric wire caulking portions 23c so as to overlap the inserted electric wire.

The tab 24 includes a bottom face portion 24a, a first folded portion 24b formed by bending a portion extending from one of right and left sides of the bottom face portion 24a, and a second folded portion 24c formed by bending another portion extending from the other one of the right and left sides thereof. The first folded portion 24b is provided all over from a foot portion to a tip end portion. Further, as shown in FIG. 3D, the first folded portion 24b is bent in a doubly overlapping manner with respect to the bottom face portion 24a, and a lower plane of the doubly overlapping structure comes into substantial contact with the bottom face portion 24a. The second folded portion 24c is provided only on the foot portion and bent so that a lower plane thereof comes into substantial contact with the first folded portion 24b as shown in FIG. 3C. Accordingly, the foot portion of the tab 24 is formed as fourfold consisting of the bottom face portion 24a and the first and the second folded portions 24b and 24c, and the portion other than the foot portion of the tab 24 is formed as threefold consisting of the bottom face portion 24a and the first folded portion 24b, respectively.

According to the connector terminal 21, the foot portion of the tab 24 is formed as fourfold consisting of the bottom face portion 24a and the first and the second folded portions 24b and 24c. Therefore, the foot portion of the tab 24 is given high geometrical moment of inertia and section modulus, thus enhancing strength and rigidity of the foot portion of the tab 24.

Moreover, in the above-described third embodiment, the overlap of the tab 24 in the portion other than the foot portion is made threefold. Therefore, the portion other than the foot portion of the tab 24 shows geometrical moment of inertia and a section modulus which are higher than those in the case of forming the bottom face portion 24a and the first folded portion 24b in the portion other than the foot portion of the tab 24 into a twofold structure. Hence, strength and rigidity of the portion other than the foot portion of the tab 24 are further enhanced as well.

In the respective embodiments described above, the threefold structure or the fourfold structure has been formed by providing the first and the second folded portions 4b, 4c, 14b, 14c, 24b and 24c extending from the both right and left sides of the bottom face portions 4a, 14a and 24a, and by bending these folded portions accordingly. However, the threefold or the fourfold structure may be also formed by providing a single folded portion extending from either the right or the left end of the bottom face portions 4a, 14a and 24a and by bending the folded portion accordingly. Nevertheless, it is preferred to provide the first and the second folded portions 4b, 4c, 14b, 14c, 24b and 24c extending from the both right and left sides of the bottom face portions 4a, 14a and 24a, and to bend these folded portions accordingly to form threefold or greater overlapping structures, because bending operations are easier, and strength and rigidity can be enhanced.

In the respective embodiments described above, although the first and the second folded portions 4b, 4c, 14b, 14c, 24b and 24c are formed by bending so as to form the foot portions of the tabs 4, 14 and 24 into the threefold or the fourfold structure, it is also possible to form the foot portion by bending so as to constitute a fivefold structure or greater. In such a case, if a tab includes a structure with a greater number of overlaps, strength and rigidity of such a tab will be enhanced further.

Although only three embodiments of the invention have been disclosed and described, it is apparent that the other embodiments and modification of the invention are possible.

What is claimed is:

1. A connector terminal comprising:
a terminal base portion; and
a tab extending from the terminal base portion to come into contact with an opponent terminal, the tab including:
a bottom face portion; and
a folded portion extending from the bottom face portion formed by bending,
wherein the bottom face portion and the folded portion at a foot portion of the tab overlap each other to constitute at least a threefold structure.

2. The connector terminal according to claim 1, wherein the folded portion of the tab is bent to be formed into a substantially uniform shape from the foot portion to a tip end portion thereof.

3. The connector terminal according to claim 1, wherein the folded portion of the foot portion of the tab is bent so as to overlap the bottom face portion providing a space therebetween.

4. The connector terminal according to claim 1, wherein the folded portion of a portion other than the foot portion of the tab is bent so as to overlap the bottom face portion providing a space therebetween.

5. The connector terminal according to claim 1, wherein the folded portion of the foot portion of the tab is bent so that the folded portion comes into substantial contact with the bottom face portion.

6. The connector terminal according to claim 1, wherein the folded portion of a portion other than the foot portion of the tab is bent so that the folded portion comes into substantial contact with the bottom face portion.

7. The connector terminal according to claim 1, wherein the bottom face portion and folded portion of the foot portion of the tab form a fourfold structure collectively.

8. The connector terminal according to claim 1, wherein the bottom face portion and folded portion of a portion other than the foot portion of the tab form a threefold structure collectively.
